(19) United States
(12) Patent Application Publication
(10) Pub. No.: US 2006/0121166 A1
(43) Pub. Date: Jun. 8, 2006

(54) Ultraviolet light reflective composition for fishing apparatus

(76) Inventor: Milan Jeckle, Spokane, WA (US)

Correspondence Address: KEITH S BERGMAN;ATTORNEY AT LAW, 7 SOUTH HOWARD STREET, SUITE 418, SPOKANE, WA, 992013898, US

(21) Appl. No.: 11/294,086

(22) Filed: Dec. 5, 2005

Related U.S. Application Data
(60) Provisional application No. 60/633,562, filed on Dec. 6, 2004.

(51) Int. Cl. A23K 1/18; C09C 1/36

(52) U.S. Cl. 426/395; 106/436

(57) ABSTRACT

A spray-on ultra violet light reflective composition for application on natural and synthetic baits and lures used in fishing activities, and the process for making the composition. The composition is made in three phases each separately mixed and thereafter combined. In phase A, a thickener, optionally a preservative, a pH adjuster and distilled water are combined and mixed. In phase B, a disperser, a solvent, a film forming polymer and a pH buffer are combined and mixed. The mixtures of phase A and phase B are combined, mixed and heated. In phase C, Titanium dioxide, a UV reflectant, a wetting agent and emulsifiers, and optionally a surface smoother, are combined and mixed. The mixture of phase C is heated and added to the heated phase A and phase B mixture. The composition is thereafter cooled, diluted and homogenized.

### RELATED APPLICATIONS

This Application claims the benefit of U.S. Provisional Application No. 60/633,562 filed on Dec. 6, 2004.

### BACKGROUND OF INVENTION

1. Field of Invention

The present invention relates generally to apparatus used in fishing activities, and more particularly to a spray coating applied to baits and lures which reacts with ultraviolet light to increase perceptibility by fish and crustaceans.

2. Background and Description of Prior Art

Color is an interpretation of light waves having a particular wavelength. While it is an organism's eye that receives light waves, it is the organism's brain that interprets those light waves and “sees” colors.

A transparent lens called the cornea is at the front of the eye to allow light waves into the eye. Behind the cornea is the iris, which gives the eye its color. By changing size, the iris regulates the amount of light entering the pupil, which is the orifice defined by the iris. Located behind the iris is a crystalline lens which focuses the light rays entering the eye onto the retina. The retina is the inner most layer of the eye and is covered with photo receptor cells. Light waves enter the eye through the cornea, pass through the pupil are focused by the lens and strike the photo receptors on the retina.

There are two types of photo receptors, rods and cones, which are named for their relative shapes. Rod type photo receptors perceive the intensity of light and enable an organism to see at night. Cone type photo receptors perceive the wavelengths of various light waves and enable the organism to distinguish colors.

Humans are among the minority of mammals that have color vision. In the human eye, rods are found at the peripheral regions of the retina but are nearly absent from the center of the visual field, known as the fovea, where the cones are concentrated. The human eye has about 150,000 cones (color receptors) per square millimeter of fovea area. Humans' eyes have three variants of photo-receptive cones (known as red cones, blue cones and green cones) and for that reason humans are classified as trichromic organisms. Each variant of photo receptive cone carries a unique protein, called an opsin, that reacts when struck by light waves having wavelengths that correspond to the opsin's light sensitivity. It is unknown whether the reaction is physical, chemical or both. The reaction of the opsin is communicated to the brain allowing the organism to distinguish between red, blue and green colors. Thus, the world visually perceived by humans is dominated by light having wave lengths ranging from 400-750 nanometers, or blue to red respectively.

In contrast to humans, bony fish and crustaceans have tetra-chromic vision. The eyes of tetra-chromic organisms have four variants of photo receptive cones. In addition to having three variants of cones with opsins sensitive to red, green and blue light, bony fish and crustaceans have a fourth variant of cone with an opsin that is sensitive to UV light which presumptively enables the organism to perceive ultra violet light that is invisible to humans. The peak sensitivity of the opsin on this fourth variant of photo receptive cone is at about 358 nanometers which is known as Ultra Violet A (UVA) light.

As noted above, while a human eye has about 150,000 cones per square millimeter of fovea area, the eyes of bony fish and crustaceans have more than one million cones per square millimeter of fovea area. This large difference in the number of cone type photo receptors in the fovea presumptively provides bony fish and crustaceans with greater visual acuity than humans, as well as an ability to perceive UV light that is invisible to humans.

Ultra violet light penetrates more deeply into water than visible light and ultraviolet light is abundant in near surface marine ecosystems. It is estimated there is sufficient UV light for UV vision down to a depth of approximately 200 meters in clear ocean water, while visible light penetrates clear ocean water to a depth of only approximately 20-40 meters. The current prevailing hypothesis is that UV vision is primarily used by fish and crustaceans to improve detection of prey.

The prior art discloses various compositions and substances, commonly known as scents that allegedly make baits and lures more appealing to fish and crustaceans by means of olfactory stimulation. The instant composition is distinguishable from scents because it does not stimulate the olfactory senses but rather is a composition that presumptively appeals to the visual senses of fish and crustaceans.

The instant invention reflects light, and especially UV light, off treated surfaces making baits and lure more perceptible to bony fish and crustaceans and theoretically more likely to cause the fish and crustacean to attempt to eat the treated bait or lure.

The instant invention is a spray-on, quick drying, water resistant composition that promotes and enhances the effectiveness of natural and synthetic baits and lures in attracting fish and crustaceans. The composition presumptively functions by various methodologies including reflecting light waves, and especially UV light waves, at incident wave lengths, reflecting light waves at altered wave lengths, leaving a trail of light reflecting crystals as treated baits and lures move through the water, and it appears the composition may be doing more than merely reflecting light waves, and especially UV light waves, although the nature of how this might be occurring is presently unknown.

### SUMMARY OF INVENTION

My invention provides a spray-on, water resistant colloidal composition that reflects light and especially “UV” light. The composition is made in three individual phases which are heated and thereafter combined. The composition comprising distilled water, Carbopol ETD, Versene 100, Phenonip, Propylene glycol, Dermacryl 79, Triethanolamine, Tegosoft TN 2, Titanium dioxide, Tego Care 450 and Dow Corning 200/10 CST.

In providing such a composition, it is:

A principal object to provide a colloidal composition for application on natural and synthetic baits and lures used in fishing activities to reflect light and especially UV light off treated surfaces so that the light waves may be perceived by bony fish and crustaceans.

A further object is, to provide such a colloidal composition that may be applied with a spray type applicator onto natural and synthetic baits and lures used in fishing activities.

A further object is to provide such a colloidal composition that is water resistant and quick drying.

A further object is to provide such a colloidal composition that reflects light waves, and especially UV light waves, at the incident wavelength.

A further object is to provide a stable colloidal composition which suspends particles of reflective, and especially UV light reflective, material within the water based carrier medium of the composition.

A further object is to provide a colloidal composition which when applied to a natural or synthetic bait or lure causes the bait or lure to be more perceptible by and attractive to bony fish and crustaceans.

A further object is to provide a colloidal composition that may be applied to a natural bait, such as a worm, without killing the natural bait.

A still further object is to provide such a colloidal composition that is new and novel, of durable and stable nature, of simple and economic manufacture and that is otherwise well suited for the uses and purposes for which it is intended.

Other and further objects of my invention will appear from the following specification and accompanying drawings which form a part hereof. In carrying out the objects of my invention it is to be understood that its features are susceptible to change in design, order and arrangement with only one preferred and practical embodiment of the best known mode being illustrated in the accompanying drawings and specified as is required.

### BRIEF DESCRIPTIONS OF THE DRAWINGS

FIG. 1 is a graphic illustration of light waves passing through water, striking and reflecting off a bait being drawn through the water by a fishing line.

FIG. 2 is a graphic illustration of the bait of FIG. 1 having a coating of the instant composition showing some of the light reflecting crystals falling off the bait and leaving a light reflecting trail therebehind as the bait is drawn through the water by a fishing line.

### DESCRIPTION OF PREFERRED EMBODIMENT

The chemical ingredients used in the preferred embodiment of the composition are identified by chemical name and common trade name in Table 1. The International Nomenclature for Cosmetic Ingredients (INCI) chemical names have been provided. Other chemicals having the same properties but produced by other manufacturers and having different trade names may be equally suitable for manufacture of the composition.

The instant invention provides a stable spray-on water resistant ultraviolet (UV) light reflective composition having the following ingredients:

TABLE 1

| Ingredient: | | |
|---|---|---|
| Manufacturer: | | |
| Address: | INCI Designation: | Purpose: |
| Carbopol ETD | Acrylates/C10-30 | thickener |
| Noveon, Inc. | Alkyl Acrylate | |
| Cleveland, OH | Crosspolymer | |
| Versene 100 | Tetrasodium EDTA | pH adjuster, |
| Dow Chemical Co. | (Ethylenediamine | chelating agent |
| Midland, MI | Tetraacetic Acid) | |
| Phenonip | Phenoxyethanol | preservative |
| Clariant UK, Ltd. | | |
| Leeds, UK | | |
| Propylene Glycol | 1,2 Propanediol | solvent, cross- |
| Spectrum Chemical Mfg. | | linking agent |
| Gardena, CA | | |
| Dermacryl 79 | Acrylates/Octyl- | film forming |
| National Starch & | acrylamide | polymer |
| Chemical Co. | Copolymer | |
| Bridgewater, NJ | | |
| Triethanolamine | Triethanolamine | pH buffer, |
| National Starch & | 99% | emulsifier, |
| Chemical Co. | | chelating agent |
| Bridgewater, NJ | | |
| TegoSoft TN2 | C12-15 Alkyl | wetting agent, |
| Goldschmidt Chemical Co. | Benzoate | emulsifier |
| Hopewell, VA | | |
| Titanium dioxide | Titanium dioxide | UV light |
| Spectrum Chemical Mfg. | | reflectant |
| Gardena, CA | | |
| Tego Care 450 | Poly Glyceryl-3 | emulsifier |
| Goldschmidt Chemical | Methyl glucose | |
| Corp. | Distearate | |
| Hopewell, VA | | |
| Dow Corning 200/10 CST | Dimethicone | surface |
| Dow Chemical Co. | | smoother |
| Midland, MI | | |
| Distilled Water | water | carrier medium |

The described process of manufacture forms a stable liquid colloidal composition that may be applied with a spray applicator or otherwise, and when dry forms a layered water resistant matrix having light reflective material, and especially UV light reflective material, therein.

The light reflective Titanium dioxide crystals of the instant invention are insoluble in water by nature. Forming of a stable colloidal composition with such crystals requires that the crystals be stabilized so they will not separate from the carrier medium. Tego Care 450 and Tegosoft TN 2 are elongate molecules having one end portion that is hydrophilic and an opposing end portion that is hydrophobic. These elongate molecules adhere to the Titanium dioxide crystals so they do not coalesce and settle-out of the composition. The result is a stable colloidal composition with a water carrier medium holding the Titanium dioxide crystals in suspension. The inclusion of Phenonip, which is a preservative, and Dow Corning 200/10 CST, which is a surface smoother, in the composition is not essential to operability but is preferable to provide longer shelf-life and give the composition more appealing texture to both fish and user.

The composition is made in three phases to maintain the proper pH balance for each phase and to ensure that the intermediate chemical reactions occur as desired. Manufacture in three separate phases also prevents undesirable premature reactions between ingredients of the separate phases with each other.

Phase A. 309.60 milliliters of distilled water is added to a 5 liter beaker. A magnetic stir bar is placed in the beaker containing the water and operated to create a vortex in the water. 0.90 grams of Carbopol ETD, which is a thickener, is slowly added to the beaker containing the distilled water and mixed for approximately 15 minutes while maintaining a vortex in the mixture throughout the mixing. Following the mixing, the Carbopol ETD should be evenly dispersed and all “fish-eyes” should have disappeared. 0.77 grams of Versene 100, which is a pH adjuster and chelating agent, is slowly added to the mixture of distilled water and Carbopol ETD and mixed with the magnetic stir bar at a moderate speed of approximately 5 revolutions per second. 0.35 grams of Phenonip, which is a preservative, optionally is added to the mixture in the beaker to prevent bacterial or fungal growth in the composition. Phase A is mixed as described because the pH of the mixture is material. Versene 100 is a weak base and pH adjuster and also a chelating agent. When combined with water, the Versene 100 increases the pH of the mixture so that the Carbopol ETD is more completely drawn into colloidal suspension. Without inclusion of Versene 100, the Carbopol ETD has less colloidal suspension. The Phase A mixture is set aside.

Phase B. 20.18 grams of Propylene Glycol, which is a solvent and cross-linking agent, is placed in a 2 liter beaker. 10.00 grams of Dermacryl 79, which is a water resistant film forming polymer, is added to the beaker containing the Propylene Glycol and mixed by hand with a glass stir rod until all “fish-eyes” have disappeared. The result is a thick white oily paste. 3.55 grams of Triethanolamine, which is a pH buffer, emulsifier and chelating agent, is added to the mixture of Propylene Glycol and Dermacryl 79 and mixing is continued with the glass stir rod until the mixture appears to be a uniform thick white oily paste. The Dermacryl 79 combines with the Triethanolamine to create a reaction product which is soluble in water. The Propylene Glycol is an additional solvent that ensures that the Dermacryl 79 dissolves into the mixture completely.

Combining Phase A and Phase B. The mixture made in Phase B is transferred into the 5 liter beaker containing the mixture made in Phase A. A stir bar is used to mix the Phase A and Phase B mixtures while heating the combined mixtures to 80° C. At first, the mixture of Phase B forms a separate layer on the surface of the Phase A mixture, but as the mixing and heating is continued the two mixtures thin and combine to form a homogeneous white mixture. The combined Phase A and Phase B mixture is maintained at 80° C.

Phase C. 65.00 milliliters of distilled water, which is a carrier medium, is added to a 2 liter beaker and stirred with a magnetic stir bar at a moderate speed of approximately 5 revolutions per second. 30.02 grams of Tegosoft TN2, which is an emulsifier and wetting agent, is added to the beaker containing the distilled water. The Tegosoft TN2 does not mix with the distilled water, but instead forms a separate layer on the surface of the distilled water. 25.06 grams of finely particulated forms of Titanium dioxide, which is a light reflectant, is added to the beaker containing the distilled water and the Tegosoft TN2. The Titanium dioxide does not immediately mix with either the Tegosoft TN2 or the distilled water but rather appears to settle in the bottom water layer as a combined suspension and sludge. 15.01 grams of Tego Care 450, which is an emulsifier, is added to the beaker containing the foregoing Phase C mixture. The particles of Tego Care 450 do not combine with any of the other ingredients in the beaker, but instead fall to the bottom of the mixture. Because a magnetic stir bar is unable to stir the mixture by itself, a glass stir rod is used in combination with the magnetic stir bar. The combined methods of mixing cause a large portion of the Tego Care 450 particles to break up forming a suspension in the mixture. 15.05 grams of Dow Corning 200/10 CST, which is a surface smoother and lubricant for spray nozzles, is added to the beaker containing the Phase C mixture while the magnetic stir bar and glass stir rod mixing is continued and the mixture is heated to 80° C. As the mixing and heating continue, the ingredients combine to form a homogenous liquid mixture having a light yellow color that thickens as it is heated. The Tegosoft TN2 and the Tego Care 450 hold the Titanium dioxide crystals in suspension. The Tegosoft TN 2 also enhances the uniform distribution of the Titanium dioxide crystals throughout the mixture.

Combining Phase C with the Phase A and Phase B combination. After being heated to 80° C., Phase C is added to the 5 liter beaker containing the combination of Phase A and Phase B mixtures already at 80° C. The newly combined mixture is held at 80° C. for approximately 15 minutes while mixing with a magnetic stir bar continues until a thick white homogenous mixture forms in the beaker.

The mixture is allowed to cool to approximately 35° C. and is then diluted with distilled water at a volume ratio of four parts distilled water to one part mixture. Thereafter, the diluted colloidal mixture is mechanically homogenized at approximately 25,000 rpm for a period of approximately five minutes.

Testing of the ultraviolet light reflectance of this composition showed the following:

### EXAMPLE 1

A transparent coating of the colloidal composition was applied to a glass slide with a spray bottle and allowed to dry. The transparent layer is not visible on a test slide without magnification. An uncoated glass control slide provided a comparison measurement for reflectance. The slides were simultaneously exposed to a single light source and reflectance of the light from the test slide and the control slide was measured for light having wave lengths of 350 nanometers and 450 nanometers. The measurements showed the test slide, having the transparent layer of the composition, reflected approximately 43% more 350 nanometer light waves than the control slide, and 50% more 450 nanometer light waves than the control slide.

### EXAMPLE 2

A translucent layer of the composition was applied to a glass slide with a spray bottle and allowed to dry. The translucent layer has a slightly milky appearance and is visible on a test slide without magnification, but is not opaque. An uncoated glass control slide provided a comparison measurement of reflectance. The slides were simultaneously exposed to a single light source and reflectance of the light from the test slide and the control slide was measured for light having wave lengths of 350 nanometers and 450 nanometers. The measurements showed the test slide, having the translucent layer of the composition, reflected approximately 292% more 350 nanometer light waves than the control slide, and 275% more 450 nanometer light waves than the control slide.

Having described the structure and composition of my ultraviolet light reflective colloidal composition its use and operation may be understood.

In the preferred method of application, a bait 10 or lure (not shown) is secured to a fishing line 12 or hook 11 in customary fashion, or the bait 10 is placed in a bait apparatus such as a crustacean trap. The bait 10 or lure is coated with the instant composition, preferably using a spray type applicator of known construction, such that the exterior surfaces of the bait 10 or lure are coated. The composition is allowed to dry, which takes approximately 1-5 minutes depending upon temperature and humidity conditions. Thereafter the bait or lure is used in a customary fashion.

Although the composition is stable and water resistant, it may be necessary to reapply the composition to baits and lures after a period of use and after extended exposure to the water and strikes by fish.

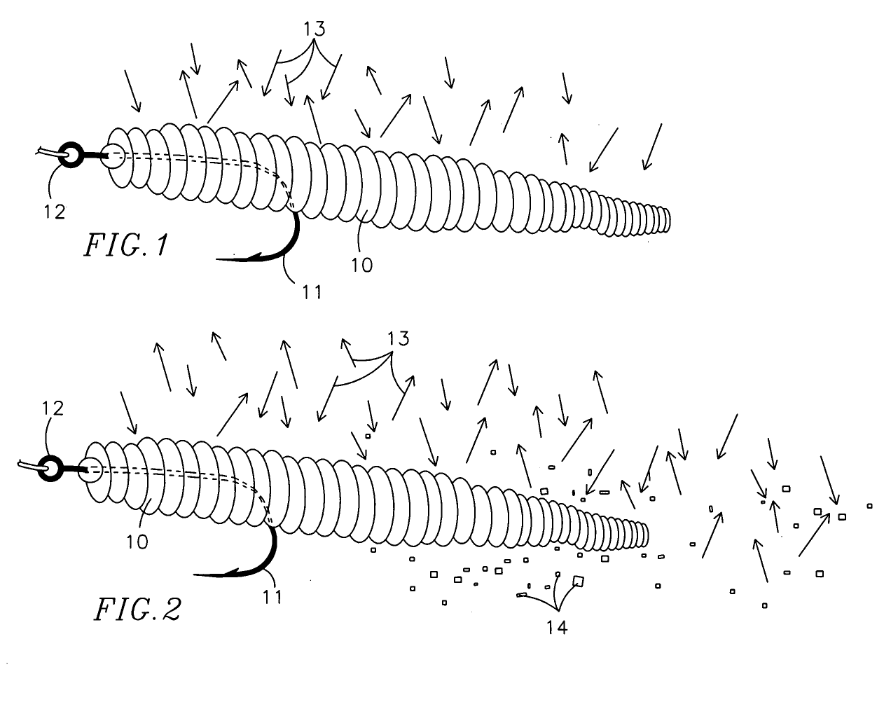

Use of the ultraviolet light reflecting coating composition on a worm is shown in FIG. 1 wherein there is seen a bait 10, a worm in this illustration, carried on a hook 11 attached to a fishing line 12, with or without an intervening lure or flasher (not shown). Light rays 13 striking and reflected from the bait 10 are as indicated by the arrows thereon. This illustration would represent a relatively static positioning of the bait 10 in water as in the case of still fishing.

The illustration of FIG. 2 shows the bait of FIG. 1 as it would appear if moving forwardly, to the left, in a body of water, as in the case of trolling or casting and retrieving. Here, some of the diagrammatically illustrated crystals of Titanium dioxide 14 are removed from, and with portions of the instant coating composition (not shown), to leave a particulated trail about and behind the coated bait 10 as it passes through the surrounding water to further attract fish and ultimately draw the attention of fish to the bait 10.

The following are examples showing results of use of the instant ultraviolet light reflective composition in actual fishing situations:

### EXAMPLE 3

On a partly sunny day three persons were fishing from a boat for walleyed pike at the Potholes Reservoir in Washington State. All three persons were fishing with similar weighted jigs having a nightcrawler thereon. The fishing depth averaged 20 feet and the water was murky with a mild current. The subject composition was applied to one jig/nightcrawler combination and was reapplied approximately every 20 minutes thereafter. Over the course of three hours, approximately 7 a.m. to 10 a.m., the jig/nightcrawler combination treated with the composition received four strikes and three fish were landed. The fish averaged 6 pounds each. The two untreated jig/nightcrawler combinations, over the same three-hour period, received no strikes. Other fishermen using a variety of untreated baits and lures in the other boats in the near area reported receiving no strikes and landed no fish.

### EXAMPLE 4

On a cloudy day four persons were fishing from a charter boat for halibut in the Gulf of Alaska near Yakutat, Ak. All four persons were fishing with circle hooks having a salmon heads for bait thereon. The fishing depth averaged 110 to 150 feet, the water was clear and the tide was variable. The subject composition was applied to one salmon head bait and was reapplied each time the bait was brought to the boat. During the first hour of fishing the salmon head bait treated with the composition received three strikes and two fish were landed. Both halibut weighed in excess of 100 pounds. Thereafter, the composition was applied to two more of the remaining three salmon heads being used as bait. Over the following three hours, six halibut were caught. Five of the six halibut were caught on the baits treated with the composition and every halibut weighed in excess of 100 pounds. The single halibut caught on the untreated salmon head bait weighed 15 pounds.

### EXAMPLE 5

On a cloudless August day two persons were trolling for Kokanee trout on the southern portion of Coeur d' Alene Lake in Northern Idaho. Two identical fishing set-ups were used each having equal exposed lengths of similar leaded line, flashers and a wedding ring lure baited with a combination of a worm portion and two fly maggots. One of the lure/bait combinations was coated with the composition while the second lure/bait combination remained untreated. Each time the treated lure/bait combination was brought to the boat it was recoated with the composition. Both lures were trolled “7 colors” (approximately 140 feet) behind the boat at a depth estimated to be 40 feet. From approximately noon to approximately 6:00 pm the wedding ring and bait combination that had been treated with the composition received 26 strikes and 14 fish were landed. The untreated wedding ring and bait combination received six strikes and 4 fish were landed. All the fish were similar in size and weight.

### EXAMPLE 6

On a sunny September day three persons were fishing from a boat for walleyed pike on Lake Roosevelt near Seven Bays Resort in Washington State. All three persons were fishing with similar lead jigs having a single hook with a nightcrawler thereon. Fishing depth averaged 40-60 feet, the water was moderately clear and there was a mild current. The composition was applied to one jig/nightcrawler combination and was reapplied periodically thereafter. Another jig/nightcrawler combination was treated with a commercially available herring scent oil. The third jig/nightcrawler combination remained untreated. From approximately 7 a.m. to mid afternoon, the jig/nightcrawler combination treated with the composition received 12 strikes, and 10 fish were landed. The fish averaged between 2 and 5 pounds each. The herring scent jig/nightcrawler combination received two strikes and one 3 pound fish was landed. The untreated jig/nightcrawler combination received no strikes.

### EXAMPLE 7

On a mostly sunny September day two persons were fishing from a boat for walleyed pike on Lake Roosevelt near Fort Spokane in Washington State. Both persons were fishing with black colored lead jigs baited with a nightcrawler. Fishing depth averaged 40-60 feet and the water was clear with a mild current. The composition was applied to one jig/nightcrawler combination. The second jig/nightcrawler combination was treated with a commercially available herring scent oil. Over the course of the morning from approximately 8 a.m. to noon the jig/nightcrawler combination treated with the composition received 2 strikes by fish and 1 of the fish was landed. The herring scent jig/nightcrawler combination received no strikes.

### EXAMPLE 8

On a cloudless day eight persons were fishing from a charter boat for halibut near the mouth of the Soldotna River in Southeast Alaska. All eight persons were fishing with circle hooks having a salmon heads or large salmon pieces thereon for bait. Fishing depth averaged 200 to 250 feet. The water was clear and the tide varied from incoming to slack to outgoing. The composition was applied to one salmon head bait and allowed to dry. During the first hour of fishing the treated bait received three strikes and two halibut were landed. One halibut weighed 117 pounds and the second weighed 135 lbs. Over the remaining portion of the day the fishing pole having the treated bait was alternated between persons fishing because the daily limit for halibut is two fish. By the end of the day a limit of 16 halibut had been caught. Of the 16 fish total, 14 were caught on baits treated with the composition and the average weight of these halibut was 113 lbs. The two halibut caught using untreated baits weighed 27 lbs and 33 lbs.

Catch results make it appear the composition may be doing more than merely reflecting light, and UV light in particular. However the nature of how something more than reflectance might be occurring is unknown.

The foregoing description of my invention is necessarily of a detailed nature so that a specific embodiment may be set forth as is required, but it is to be understood that various modifications of detail, rearrangement and multiplication of parts might be resorted to without departing from the spirit, essence or scope of invention.

Having thusly described my invention, what I desire to protect by Letters Patent, and what I claim is:

1. An ultra violet light reflective coating composition for enhancing the effectiveness of natural and artificial baits and lures in the catching of fish, comprising:
a viscously fluidic water based polymeric composition that in its fluidic state wets the surface of natural and synthetic baits and lures sufficiently to adhere thereto and dries to a dried state in an atmospheric environment after placement on the bait and lure to form a relatively thin somewhat resilient, cohesive and uniform coating on the bait and lure reflective of ultra violet light, said coating composition
having from 0.5% to 7.0% by weight of Titanium dioxide that is particulated sufficiently fine to remain suspended in the coating composition in its fluidic state and being somewhat insoluble in and impermeable by water in its dried state.

2. The ultra violet light reflective coating composition of claim 1 further comprising:
a chelating agent to maintain the particulated Titanium dioxide in aqueous suspension, and
a film forming polymer, cross-linking agent and emulsifier to form an emulsoid with the aqueous solution which dries to create the cohesive and somewhat insoluble and water repellant surface over at least the outer portion of the coating composition in its dried state on a bait and lure.

3. The ultra violet light reflective coating composition of claim 1 containing by weight:
a thickener Acrylates/C 10-30 Alkyl Acrylate Crosspolymer from 0.04% to 0.40%;
a Ph adjuster and chelating agent Tetrasodium Ethylene-Diamine Tetraacetic Acid from 0.07% to 0.60%;
a solvent and cross-linking agent 1,2 Propanediol from 2.0% to 16.0%;
a film forming polymer Octylacrylamide Co-polymer from 1.0% to 4.0%;
a Ph buffer, emulsifier and chelating agent, Triethanolamine 99% from 0.35% to 3.5%;
a wetting agent and emulsifier, C12-15 Alkyl Benzoate from 3.0% to 12.1%;
an emulsifier Poly Glyceryl-3 Methyl glucose Distearate from 1.5% to 6.1%; and
distilled water from 91.54% to 50.3%.

4. The ultra violet light reflective coating composition of claim 1 containing by weight:
a thickener, C10-30 Alkyl Acrylate Crosspolymer 0.18%;
a Ph adjuster and chelating agent Tetrasodium Ethylene-Diamine Tetraacetic Acid 0.15%;
a solvent and cross-linking agent 1,2 Propanediol 4.07%;
a film forming polymer Octylacrylamide Co-polymer 2.02%;
a Ph buffer, emulsifier and chelating agent, Triethanolamine 0.72%;
a wetting agent and emulsifier C12-15 Alkyl Benzoate 6.05%;
a UV light reflectant of Titanium Dioxide 5.05%;
an emulsifier Poly Glyceryl-3 Methyl glucose Distearate 3.03%; and
distilled water 78.73%.

5. The ultra violet light reflective coating composition of claim 3 containing a preservative Phenoxyethanol of approximately 0.07% by weight.

6. The ultra violet light reflective coating composition of claim 4 containing a preservative of Phenoxyelthanol of approximately 0.07% by weight.

7. The ultra violet light reflective coating composition of claim 3 containing a surface smoother Dimethicone of approximately 3.03% by weight.

8. The ultra violet light reflective coating composition of claim 4 containing a surface smoother of Dimethicone of approximately 3.03% by weight.

9. The method of compounding the composition of claim 1 comprising:
forming a phase A mixture containing
a thickener C10-30 Alkyl Acrylate Crosspolymer in the
amount of 0.04% to 0.40% by weight of the final composition,
a pH adjuster and chelating agent of Tetrasodium Ethylene-diamine Tetraacetic Acid in the amount of 0.07% to 0.60% by weight of the final composition, and
distilled water in the amount of 50.3% to 91.54% by weight of the final composition;
forming a phase B mixture containing,
a solvent and cross-linking agent of 1,2 Propanediol (Propylene Glycol) in the amount of 2.0% to 16.0% by weight of the final composition,
a pH buffer, emulsifier and chelating agent of Triethanolamine (99%) in the amount of 0.35% to 3.50% by weight of the final composition, and
a film forming polymer of Octylacrylamide Copolymer in the amount of 1.0% to 4.0% by weight of the final composition; and
forming a phase C mixture containing,
an ultra violet light reflectant of finely particulated Titanium dioxide in the amount of 0.5% to 7.0% by weight of the final composition,
a wetting agent and emulsifier of C12-15 Alkyl Benzoate in the amount of 3.0% to 12.1% by weight of the final composition, and
an emulsifier of Poly Glyceryl-3 Methyl glucose Distearate in the amount of 1.5% to 6.1% by weight of the final composition; and
heating the phase A mixture to 80° C., heating the phase B mixture to 80° C. and combining and mixing the heated phase A mixture and the heated phase B mixture;
heating the phase C mixture to 80° C. and combining and mixing the heated phase C mixture with the heated, combined and mixed phase A and phase B mixtures;
cooling the combined and mixed phase A, phase B and phase C mixtures to 35° C. and diluting the cooled combined mixtures with water in a ratio of one part final combined mixtures to four parts distilled water; and
mechanically homogenizing the composition.
